(19) United States
(12) Patent Application Publication
(10) Pub. No.: US 2025/0266717 A1
(43) Pub. Date: Aug. 21, 2025

(54) WIRELESS POWER TRANSFER INITIATION

(71) Applicant: Apple Inc., Cupertino, CA (US)

(72) Inventors: Damiano Patron, South San Francisco, CA (US); Wei Li, Los Altos, CA (US); Ho Fai Leung, Auckland (NZ); Wangxin Huang, San Jose, CA (US); Vladimir N. Vitchev, San Jose, CA (US)

(21) Appl. No.: 19/020,139

(22) Filed: Jan. 14, 2025

Related U.S. Application Data
(60) Provisional application No. 63/553,848, filed on Feb. 15, 2024.

(51) Int. Cl. H02J 50/12; H02J 7/00

(52) U.S. Cl. CPC H02J 50/12; H02J 7/0047

(57) ABSTRACT

A wireless power receiver can include control circuitry that initiates wireless power transfer at a first frequency responsive to the wireless power receiver being coupled to the wireless power transmitter and transitions to wireless power transfer at a second frequency based on operating condition such as rectifier output voltage, battery condition, etc. The control circuitry can further manage circuit tuning and selective enabling/disabling of control circuit components as part of the frequency transition.

### CROSS-REFERENCE TO RELATED APPLICATIONS

This application claims priority to U.S. Provisional Application No. 63/553,848, filed Feb. 15, 2024, which is incorporated by reference herein in its entirety.

### BACKGROUND

Wireless power transfer is used in electronic devices, such as smart phones, tablet computers, smart watches, wireless earphones, styluses, and so forth, to facilitate charging of batteries within the devices. Various improvements can be made to such systems.

### SUMMARY

A wireless power receiver can include: a wireless power receiving coil configured to have a current induced therein by a wireless power transmitter; a rectifier that receives the current from the wireless power receiving coil and produces a rectifier output voltage therefrom; and control circuitry coupled to the wireless power receiving coil and the rectifier that: initiates wireless power transfer at a first frequency responsive to the wireless power receiver being coupled to the wireless power transmitter; samples the rectifier output voltage in a stable region following an initial ramp up of the rectifier output voltage; compares the sampled rectifier voltage to a threshold; and if the sampled rectifier output voltage is greater than the threshold, initiates wireless power transfer at a second frequency that is higher than the first frequency; or if the sampled rectifier output voltage is not greater than the threshold, continues wireless power transfer at the first frequency.

If the sampled rectifier output voltage is greater than the threshold, the control circuitry can further provide a notification indicating the transition to wireless power transfer at the second frequency. The notification can include at least one of an audible notification or a visual notification. The visual notification can include a notification on a display of the wireless power receiver. If the sampled rectifier output voltage is not greater than the threshold, the control circuitry can further provide a notification indicating the continued wireless power transfer at a lower operating parameter. The notification can include at least one of an audible notification or a visual notification. The visual notification can include a notification on a display of the wireless power receiver. Wireless power transfer at the second frequency can transfer power at a greater rate than wireless power transfer at the first frequency.

A wireless power receiver can include: a battery; a wireless power receiving coil configured to have a current induced therein by a wireless power transmitter; a rectifier that receives the current from the wireless power receiving coil and produces a rectifier output voltage therefrom, wherein the rectifier output voltage is supplied to charge the battery; and control circuitry coupled to the wireless power receiving coil and the rectifier that: initiates wireless power transfer at a first frequency responsive to the wireless power receiver being mated to the wireless power transmitter in a low battery condition; checks battery status to determine if battery condition can accommodate a transition to wireless power transfer at a second frequency higher than the first frequency; checks wireless power transfer link efficiency to determine if a wireless power transfer link with the wireless power transmitter can accommodate wireless power transfer at the second frequency; and if the battery status can accommodate the transition to wireless power transfer at the second frequency and the wireless power transfer link can accommodate wireless power transfer at the second frequency, initiates wireless power transfer at the second frequency; or if either the battery status cannot accommodate the transition to wireless power transfer at the second frequency or the wireless power transfer link cannot accommodate wireless power transfer at the second frequency, continues wireless power transfer at the first frequency.

The control circuitry can check battery status to determine if battery condition can accommodate a transition to wireless power transfer at a second frequency higher than the first frequency by receiving a signal indicating battery condition from a battery management system of the wireless power receiver. The signal indicating battery condition can be based at least in part on temperature, battery aging, and/or battery state of charge. The control circuitry can check wireless power transfer link efficiency to determine if a wireless power transfer link with the wireless power transmitter can accommodate wireless power transfer at the second frequency by: determining whether the rectifier output voltage and a rectifier output current reach respective target values within a time limit; if the rectifier output voltage and the rectifier output current do not reach respective target values within the time limit, inferring the presence of a foreign object and continuing wireless power transfer at the first frequency; if the rectifier output voltage and the rectifier output current do reach respective target values within the time limit, calculating efficiency of the wireless power transfer link; if the calculated efficiency does not exceed a first threshold, inferring the presence of a foreign object and continuing wireless power transfer at the first frequency; if the calculated efficiency exceeds the first threshold, but does not exceed a second threshold, continuing wireless power transfer at the first frequency; and if the calculated efficiency exceeds both the first and second thresholds, initiating wireless power transfer at the second frequency. Wireless power transfer at the second frequency can transfer power at a greater rate than wireless power transfer at the first frequency. Continuing wireless power transfer at the first frequency and initiating wireless power transfer at the second frequency each can each include providing respective notifications, wherein the respective notifications include at least one of an audible or visual notification.

A wireless power receiver can include: a wireless power receiving coil configured to have a current induced therein by a wireless power transmitter; a rectifier that receives the current from the wireless power receiving coil and produces a rectifier output voltage therefrom, wherein the rectifier output voltage is supplied to charge a battery; a plurality of tuning capacitors coupling the wireless power receiving coil and the rectifier, the plurality of tuning capacitors including one or more switched capacitors selectively couplable to or de-couplable from the wireless power receiving coil by respective switching devices; and control circuitry coupled to the wireless power receiving coil and the rectifier that: initially disables one or more components of the control circuitry until a rectifier output voltage exceeds a low voltage start threshold; upon the rectifier output voltage exceeding the low voltage start threshold, operates the rectifier in a boost mode to increase the rectifier output voltage, wherein the control circuitry further includes one or more default high control outputs coupled to the switching devices that cause the one or more switched capacitors to be coupled to the wireless power receiving coil upon the rectifier output voltage reaching the low voltage start threshold; and upon the rectifier reaching an undervoltage lockout threshold, enables the one or more initially disabled components of the control circuitry, wherein the one or more initially disabled components of the control circuitry can assume control of the rectifier and switching devices.

The one or more switched capacitors can be selectively couplable to or de-couplable from the wireless power receiving coil by respective switching devices that tune the wireless power receiver for operating at a first wireless power transfer frequency when the one or more switched capacitors are coupled to the wireless power receiving coil and tune the wireless power receiver for operating at a second wireless power transfer frequency when the one or more switched capacitors are de-coupled from the wireless power receiving coil. The second wireless power transfer frequency can be higher than the first wireless power transfer frequency. Wireless power transfer at the second frequency can transfer power at a greater rate than wireless power transfer at the first frequency.

### BRIEF DESCRIPTION OF THE DRAWINGS

FIG. 1 illustrates a simplified block diagram of a wireless power transfer system.

FIG. 2 illustrates a wireless power receiver rectifier voltage during startup of a wireless power transfer session.

FIG. 3 illustrates a startup flowchart of a wireless power transfer session using rectifier voltage to initiate a wireless power transfer frequency transition.

FIG. 4 illustrates a startup flowchart of a wireless power transfer session for a wireless power receiver with a low battery condition.

FIG. 5 illustrates a flowchart of a link efficiency estimation scheme for frequency transition when initiating a wireless power transfer session.

FIG. 6 illustrates a simplified schematic of a wireless power transfer system.

FIG. 7 illustrates a flowchart of a startup sequence for a wireless power transfer system.

FIG. 8 is a block diagram of an electronic device that can be the wireless power receiver.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather, the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

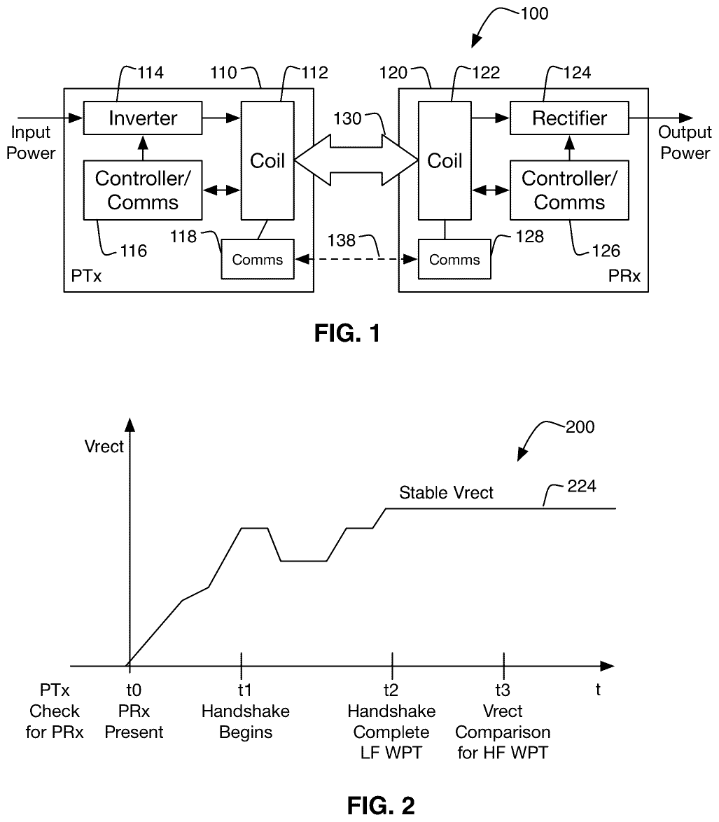

FIG. 1 illustrates a simplified block diagram of a wireless power transfer system 100. Wireless power transfer system includes a power transmitter (PTx) 110 that transfers power to a power receiver (PRx) 120 wirelessly, such as via inductive coupling 130. Power transmitter 110 may receive input power that is converted to an AC voltage having particular voltage and frequency characteristics by an inverter 114. Inverter 114 may be controlled by a controller/communications module 116 that operates as further described below. In various embodiments, the inverter controller and communications module may be implemented in a common system, such as a system based on a microprocessor, microcontroller, or the like. In other embodiments, the inverter controller may be implemented by a separate controller module and communications module that have a means of communication between them. Inverter 114 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

Inverter 114 may deliver the generated AC voltage to a transmitter coil 112. In addition to a wireless coil allowing magnetic coupling to the receiver, the transmitter coil block 112 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless transmitter coil may also include a core of magnetically permeable material (e.g., ferrite) configured to affect the flux pattern of the coil in a way suitable to the particular application. The teachings herein may be applied in conjunction with any of a wide variety of transmitter coil arrangements appropriate to a given application.

PTx controller/communications module 116 may monitor the transmitter coil and use information derived therefrom to control the inverter 114 as appropriate for a given situation. For example, controller/communications module may be configured to cause inverter 114 to operate at a given frequency or output voltage depending on the particular application. In some embodiments, the controller/communications module may be configured to receive information from the PRx device and control inverter 114 accordingly. This information may be received via the power transmission coils (i.e., in-band communication) or may be received via a separate communications channel (not shown, i.e., out-of-band communication). For in-band communication, controller/communications module 116 may detect and decode signals imposed on the magnetic link (such as voltage, frequency, or load variations) by the PRx to receive information and may instruct the inverter to modulate the delivered power by manipulating various parameters of the generated voltage (such as voltage, frequency, etc.) to send information to the PRx. In some embodiments, controller/communications module may be configured to employ frequency shift keying (FSK) communications, in which the frequency of the inverter signal is modulated, to communicate data to the PRx. Controller/communications module 116 may be configured to detect amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 116 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

PTx device 110 may optionally include other systems and components, such as a separate communications module 118. In some embodiments, comms module 118 may communicate with a corresponding module in the PRx via the power transfer coils. In other embodiments, comms module 118 may communicate with a corresponding module using a separate physical channel 138.

As noted above, wireless power transfer system also includes a wireless power receiver (PRx) 120. Wireless power receiver can include a receiver coil 122 that may be magnetically coupled 130 to the transmitter coil 112. As with transmitter coil 112 discussed above, receiver coil block 122 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless receiver coil may also include a core of magnetically permeable material (e.g., ferrite) configured to affect the flux pattern of the coil in a way suitable to the particular application. The teachings herein may be applied in conjunction with any of a wide variety of receiver coil arrangements appropriate to a given application.

Receiver coil 122 outputs an AC voltage induced therein by magnetic induction via transmitter coil 112. This output AC voltage may be provided to a rectifier 124 that provides a DC output power to one or more loads associated with the PRx device. Rectifier 124 may be controlled by a controller/communications module 126 that operates as further described below. In various embodiments, the rectifier controller and communications module may be implemented in a common system, such as a system based on a microprocessor, microcontroller, or the like. In other embodiments, the rectifier controller may be implemented by a separate controller module and communications module that have a means of communication between them. Rectifier 124 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

PRx controller/communications module 126 may monitor the receiver coil and use information derived therefrom to control the rectifier 124 as appropriate for a given situation. For example, controller/communications module may be configured to cause rectifier 124 to operate provide a given output voltage depending on the particular application. In some embodiments, the controller/communications module may be configured to send information to the PTx device to effectively control the power delivered to the receiver. This information may be received sent via the power transmission coils (i.e., in-band communication) or may be sent via a separate communications channel (not shown, i.e., out-of-band communication). For in-band communication, controller/communications module 126 may, for example, modulate load current or other electrical parameters of the received power to send information to the PTx. In some embodiments, controller/communications module 126 may be configured to detect and decode signals imposed on the magnetic link (such as voltage, frequency, or load variations) by the PTx to receive information from the PTx. In some embodiments, controller/communications module 126 may be configured to receive frequency shift keying (FSK) communications, in which the frequency of the inverter signal has been modulated to communicate data to the PRx. Controller/communications module 126 may be configured to generate amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 126 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry. PRx device 120 may optionally include other systems and components, such as a communications (“comms”) module 128. In some embodiments, comms module 128 may communicate with a corresponding module in the PTx via the power transfer coils. In other embodiments, comms module 128 may communicate with a corresponding module or tag using a separate physical channel 138.

Numerous variations and enhancements of the above-described wireless power transmission system 100 are possible, and the following teachings are applicable to any of such variations and enhancements. Described in greater detail below are various enhancements of start-up routines for a wireless power transfer system, including aspects relating to startup in systems with multiple wireless power transfer frequencies, startup of systems in which the PRx device have a low battery condition, etc.

In at least some wireless power transfer systems, multiple frequencies may be used for wireless power transfer. The higher frequency may be desirable for a variety of reasons, such as higher power transfer rates (allowing for, among other things, faster battery charging), avoidance of interference, reduced size of magnetic components, etc. Nonetheless, it may also be desirable to provide for wireless power transfer at lower frequency as well, for reasons such as increased compatibility with older, pre-existing, or different devices, etc. In some such devices, a wireless power transfer session may be initiated at a first frequency, e.g., a lower frequency and then, if both devices are capable and other conditions are suitable, transition to a higher frequency. Pre-existing devices have relied on relatively complex communication between the PRx device and PTx device to determine whether device capabilities and operating condition will accommodate a transition to a higher frequency and power transfer level. However, a simplified technique based on the PRx rectifier output voltage as described herein can enhance operation of such systems.

As described above, a wireless power receiver 120 (a/k/a PRx device) can include a wireless power receiver coil 122 that has an AC voltage induced therein by a corresponding wireless power transmitter coil 112 of a wireless power transmitter 110 (a/k/a PTx device). This induced AC voltage can be provided to a rectifier 124, which can produce a DC voltage that can be used to power various loads associated with the PRx, for example to charge a battery of a device such as a smartphone, smartwatch, wireless earphone, stylus, or other personal electronic device or accessory.

FIG. 2 illustrates a plot 200 of an exemplary wireless power receiver rectifier voltage 224 versus time during startup of a wireless power transfer session. Initially, prior to the start of the wireless power transfer session, the PTx device can be periodically checking for the presence of the PRx device. This can include the wireless power transmitter sending periodic “ping” signals and analyzing the response of the transmitter side resonant circuitry to determine whether a PRx device is present. When the PRx and PTx device are brought in proximity so that the respective wireless power transfer coils can couple to on another, the parameters of the resonant circuit seen by the PTx will be altered by the presence of the PRx device, and the transmitter can know that a PRx is present. As a result, the PTx can energize the wireless power transmitter coil 112, by operation of inverter 114 as described above. This will begin inducing a voltage in wireless power receiver coil 122, initiating operation of rectifier 124, and causing the rectifier output voltage (Vrect) to begin increasing, illustrated as beginning at time t0 in FIG. 2.

Once the rectifier voltage Vrect has reached a value (e.g., a voltage required to reliably operate the PRx system components) at time t1, the PRx and PTx can use their respective communication circuitry to initiate communication and negotiate the wireless power transfer parameters that will be used during the wireless power transfer session. This is illustrated in FIG. 2 as a handshaking process beginning at time t1 and ending at time t2 with initiation of a low frequency (and/or low power) wireless power transfer session. This handshaking process may take place according to an industry standard protocol, such as the Qi standards promulgated by the wireless power consortium, or according to a proprietary protocol defined by one or more device manufacturers. In some cases, the handshaking can begin according to a baseline protocol, allowing for enhanced interoperability between devices from different manufacturers, and transitioning to an extended protocol to support enhanced features. In any case, once the handshaking process is completed (at time t2), the rectifier output voltage Vrect will reach a stable value. As described in greater detail below, measurement of this stable voltage and comparison to a threshold can be used to trigger initiation of a transition from an initially negotiated first set of operating parameters to a second set of operating parameters. Exemplary operating parameters include operating frequency and wireless power transfer level. In some examples, the first set of operating parameters cause wireless power transfer to occur in a low or relatively lower frequency. In some examples, the second set of operating parameters cause wireless power transfer to occur at a high or higher (relative to the first operating parameters) frequency. In some examples, the second set of operating parameters cause wireless power transfer at a higher power level relative to the first set of operating parameters.

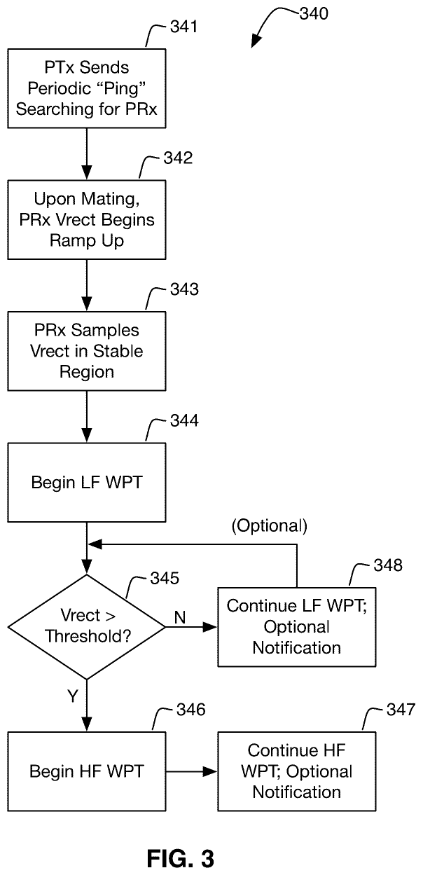

FIG. 3 illustrates a startup flowchart 340 of a wireless power transfer session using rectifier voltage to initiate a wireless power transfer frequency transition. Beginning in block 341, the PTx device can send periodic “ping” signals, searching for the presence of a PRx device. In block 342, when the PRx device is present and the respective wireless power transfer coils are coupled (mated), the PRx rectifier voltage (Vrect) can begin to ramp up. Then, in block 343, the PRx device, more specifically its control circuitry, such as controller/communication circuitry 126, can sample Vrect in the stable region after initial handshaking as described above. Substantially contemporaneously therewith, the PRx and PTx can begin low(er) frequency and/or low(er) wireless power transfer (block 344). As but one non-limiting example, this low(er) frequency power transfer can occur at a frequency such as 326 kHz, although other values, such as 100 kHz, 128 kHz, 200kHz, 300 kHz, 360 kHz, etc. could also be used.

In block 345, the PRx (via its controller circuitry) can determine whether the stable Vrect value exceeds a threshold. This threshold can be determined by analysis and/or simulation of the PRx device during the design process. The threshold can be associated with operating conditions that can allow for operation at a higher wireless power transfer frequency and/or wireless power transfer level. Thus, the threshold can be selected to encompass parameters such as the degree of coupling between the respective wireless power transfer coils, which can be affected by relative spatial positioning of the coils, presence of conductive “foreign” objects, etc. In the presence of misalignment of the coils and/or a foreign object, it may not be desirable to transition to a higher frequency and/or higher power wireless power transfer regime. This condition can be indicated by the rectifier output voltage being below the threshold value. Thus, in block 345, if Vrect does not exceed the threshold, the system can continue with wireless power transfer at the low(er) frequency and/or low(er) power level, as indicated by block 348. In some embodiments, this continuation of low(er) frequency/power wireless power transfer (block 348) can continue until the wireless power session is completed, e.g., by the user removing the PRx device from the PTx, a battery of the PRx device being fully charged, etc.

At this point (block 348), the wireless power receiver can optionally provide a notification indicating to a user that high(er) frequency and/or high(er) power wireless power transfer is not available. This notification could take a variety of forms, such as an audible notification or a visual notification such as a status light, a message presented to the user on a display, etc. The notification can come from the PRx device, the PTx device, or a device associated with the PRx device. For example, if the PRx device is a smartwatch, the notification could come from the watch itself (such as a chime from a speaker or visual notification on the display of the watch) and/or the notification could come from a smartphone to which the smart watch is paired. Likewise, in the case of some PRx devices without user such user interface elements (e.g., a stylus, wireless earphone, etc.), the notification could come from an associated device (such as a smartphone, tablet computer, etc.). Such notification can indicate to the user that wireless power transfer is occurring at a lower rate, which might, for example, result in a longer period to charge a battery associated with the PRx device, allowing the user to plan accordingly and/or attempt to identify and/or remedy the situation that is preventing high(er) frequency/high(er) power wireless power transfer.

As a further option at this point, the PRx can continue checking whether the rectifier output voltage (Vrect) exceeds the threshold. This might occur, for example, if the PTx and PRx are brought into better alignment, if a foreign object is removed, etc. This continuing to check Vrect may be performed at periodic intervals and may optionally be subject to a maximum number of retries, a maximum time period for retries, etc. In some cases, the PRx control circuitry can be triggered by changes in operating condition (voltages, currents, etc.) to check whether the rectifier output voltage Vrect exceeds the threshold. In any case, at some point the PRx device can stop such periodic checks and proceed with low(er) frequency and/or power wireless power transfer.

If in block 345 it is determined that the rectifier output voltage Vrect exceeds the threshold, the system can transition to high(er) frequency and/or high(er) power wireless power transfer. As but one non-limiting example, this can occur at a frequency of 1.78 Mhz, although other frequencies such as 700 kHz, 800 khZ, 900 kHz, 1 MHz, 1.5 MHz, 2 MHZ, 3 MHz, 6.78 MHz, 13.56 MHz, etc. could also be used. This transition can include an initiation or beginning of the high(er) frequency wireless power transfer (block 346) and continuation of high(er) frequency/power wireless power transfer (block 347) until the wireless power session is completed, e.g., by the user removing the PRx device from the PTx, a battery of the PRx device being fully charged, etc. Also in block 347, a notification can be provided to a user, such as an audible or visual notification as described above. Such notification can indicate to a user that high(er) frequency and/or power wireless power transfer is in effect, allowing such user to plan accordingly. For example, a (first) notification for lower and a (second) notification for higher power transfer can have different colors, different animations, or other distinguishable user interface elements.

Another aspect of startup of a wireless power transfer session relates to initiating wireless power transfer when the PRx device is starting from a fully depleted battery condition, i.e., when the PRx device's battery is discharged to the point that normal operation of the PRx device systems might not be initially available. This condition is sometimes referred to, informally, as a dead battery where the device will no longer boot up. In such conditions, a PRx device such as a smartwatch, smartphone, etc. may not be running its operating system on its normal processor. Nonetheless, the wireless power transfer control circuitry (e.g., controller/communications circuitry 126) and other lower-level systems (such as a battery management controller) that require relatively low power levels to operate may be running. In some instances, this base level of computing is initiated by the ongoing wireless power signal. Thus, such systems can initiate wireless power transfer to the PRx, allowing the PRx battery to be charged to a state allowing for “normal” operation.

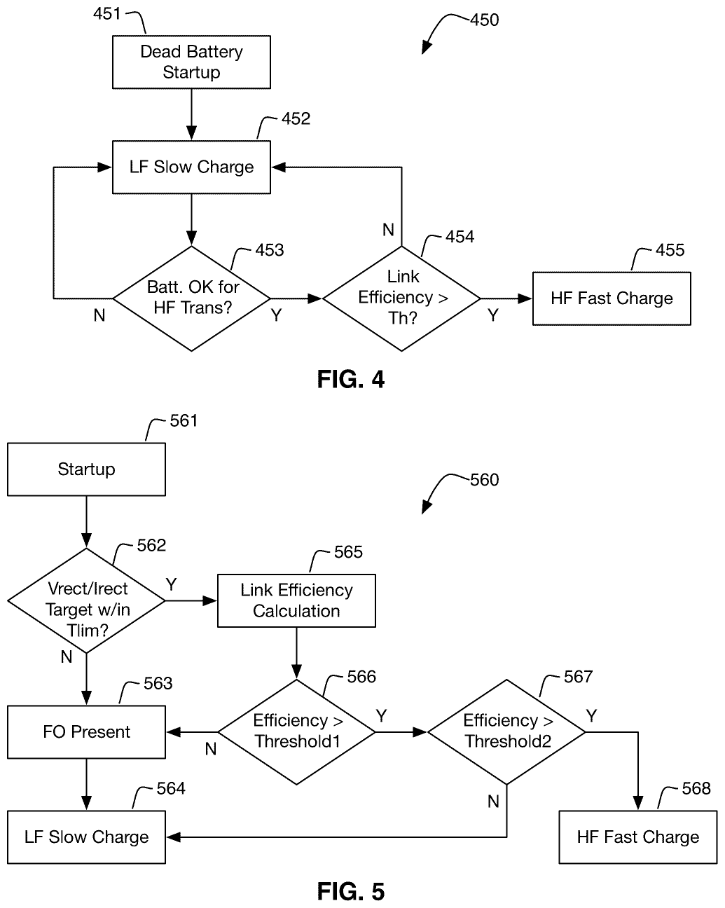

FIG. 4 illustrates a startup flowchart 450 of a wireless power transfer session for a wireless power receiver (PRx) with a low battery condition, beginning in block 451. With block 452, the wireless power transfer system, more specifically the wireless power receiver control circuitry acting in cooperation with the PTx device, can initiate low(er) frequency/power wireless power transfer, which can be used to begin charging a battery associated with the PRx device. Heretofore, this low(er) frequency/power charging would have continued until the battery was sufficiently charged to initiate a transition to a high(er) frequency/power wireless power transfer session.

In the illustrated embodiment, the wireless power receiver controller can determine, in block 453, whether the battery condition is ok for a transition to high(er) frequency/power wireless power transfer, which can allow for faster battery charging, shortening the time until the device can boot its operating system and run “normally” as well as decreasing the time required to fully charge the battery. Whether the battery condition is ok for a transition to high(er) frequency/power wireless power transfer is a function of the fact that wireless power transfer will be temporarily interrupted during the transition. Thus, the battery needs to have sufficient energy stored therein to power the PRx during the transition until wireless power transfer is restored. Thus, whether the battery condition is “ok” for such a transition is a function of the state of charge of the battery. The ok battery condition may also be affected by other factors that affect how long the battery with the given state of charge can power the system. For example, temperature extremes, either hot or cold, may affect the time that the battery can keep the system running. Similarly, battery aging can cause increased battery impedance, reduced full charge state, etc. that can affect the amount of time that the battery can operate the PRx systems in a given state of charge. Various combinations of these and other parameters can be used to determine the battery ok state.

The wireless power control circuitry can make the determination whether the battery is okay for frequency transition (block 453) in a variety of ways. In one embodiment, the wireless power control circuitry can simply receive a signal from the battery management system indicating whether the battery is okay for transition. Thus, the power system of the device can include a battery management system that monitors battery state of charge, health, voltage, temperature, etc. to determine whether the battery state is sufficient to continue powering the device through a frequency transition and, once this condition is met, can provide such a signal to the wireless power control circuitry. In other embodiments, the wireless power control circuitry can receive inputs from various sensors allowing it to make such a determination, although the former may be preferred as the latter might result in duplication of functionality already present in a battery management system for other reasons.

In any case, in block 453, the wireless power receiver control circuitry can determine whether the battery condition is ok for transition to a high(er) frequency/power wireless power transfer operation. If not, then low(er) frequency/power charging (block 452) can continue until the battery condition is ok. Once the battery condition is ok (block 453), then the wireless power receiver control circuitry can determine whether the wireless power transfer link efficiency exceeds a threshold. Wireless power transfer link efficiency (block 454) can be determined as the rectifier output voltage (Vrect) times rectifier output current (Irect) divided by the product of boost input voltage and boost input current, as measured by the PTx control circuitry and communicated to the PRx, for example as described above with respect to FIG. 1. If the wireless power link efficiency exceeds a predetermined threshold, then the system can transition to high(er) frequency/power wireless power transfer and charging (block 455). Otherwise, if the link efficiency is less than the threshold, low(er) frequency/power wireless power transfer and charging can continue (block 452). The efficiency threshold can be determined by analysis and simulation during the PRx design process. As an example, a wireless link efficiency on the order of 45-50% or more may be sufficient to support high(er) frequency operation. In some embodiments, it may be possible to use rectifier output voltage as a substitute for link efficiency, as was described above with reference to FIGS. 2-3.

FIG. 5 illustrates a flowchart 560 of a link efficiency estimation scheme for frequency transition when initiating a wireless power transfer session. This process may be executed by the wireless power receiver control circuitry. Beginning with startup in block 561, the circuitry can determine whether the wireless power receiver rectifier output voltage (Vrect) and current (Irect) reach appropriate target values within a certain limiting time period (Tlim) (block 562). Sufficiently fast ramp up of these parameters indicates a robust inductive link between the PTx and PRx, while the lack of a sufficiently fast ramp up may be indicative of issues such as the presence of a foreign object. Thus, the target values and time limit may be determined as part of the PRx design process based on analysis, simulation, and/or other characterization of the PRx and the wireless power transfer system(s). As indicated above, if these parameters do not reach the target values within an appropriate time limit, the delay can indicate the presence of a foreign object (block 563), resulting in low(er) power wireless power transfer and charging (block 564). The low(er) power transfer levels may also take place at a low(er) wireless charging frequency.

Alternatively, if the rectifier output voltage and current do reach the target values within the time limit, the wireless power control circuitry can perform a link efficiency calculation (block 565). As described above link efficiency can be defined as the rectifier output voltage (Vrect) times rectifier output current (Irect) divided by the product of boost input voltage and boost input current, as measured by the PTx control circuitry and communicated to the PRx. The resulting link efficiency determined by the wireless power receiver can be compared to a first threshold (block 566). If the efficiency is not greater than the first threshold, this can indicate the presence of a foreign object (block 563) resulting in low(er) frequency/power wireless power transfer and charging (block 564). Otherwise, the determined efficiency can be compared to a second threshold (block 567). If the efficiency is greater than the second threshold, then high(er) frequency/power wireless power transfer and charging may begin (block 568), otherwise, low(er) frequency/power wireless power transfer and charging may begin (block 564). The first threshold may be a threshold determined to be indicative of a foreign object's presence, and may be a value such as 35%, 40%, 45%, etc. The second threshold may be a threshold determined to be indicative of sufficient alignment between the wireless power transfer coils, and may be higher than the first threshold, such as a value of 40%, 45%, 50%, etc. Additionally, each of the respective frequency/power level wireless power transfer and charging states may optionally be associated with user notifications as described above, although in the case of a low battery voltage, audible notifications may be preferred or required as there may not be sufficient power to drive a display or other visual notification device.

The above-described embodiments describe various aspects of initiating wireless power transfer and a transition to a high(er) frequency/power wireless power transfer regime, including at least some cases in which the PRx device is operating in a low power state in which certain functionality may not be available. Additionally, operating at different frequencies can necessitate tuning of the wireless power receiving circuitry to match the desired frequency. As described in greater detail below, such tuning circuitry may default to a higher frequency state, while tuning to the lower frequency state may require actuation of switches to tune the receiver circuit when power may not be available to perform such actuation. This can result in a tuning mismatch that can decrease the wireless power transfer level until such time as appropriate tuning can be accomplished, which can further delay such tuning. Thus, the wireless power control circuitry can be designed to enhance operation by accelerating the required circuit tuning and thereby more rapidly enabling the desired level of wireless power transfer.

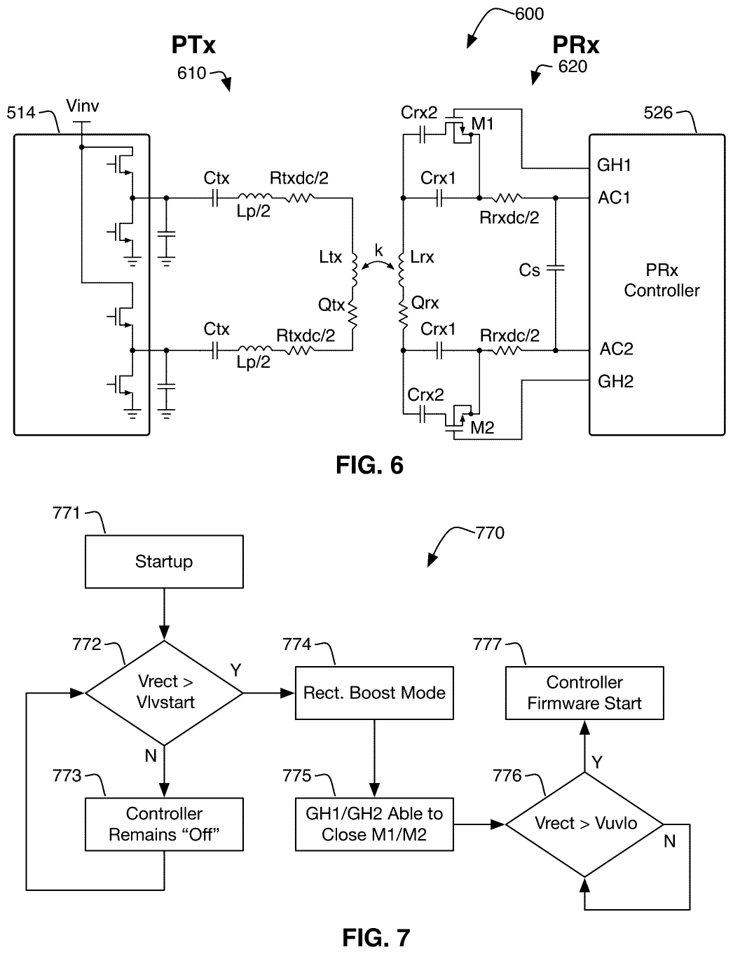

FIG. 6 illustrates a simplified schematic 600 of a wireless power transfer system. The PTx 610 can include an inverter 514 and a wireless power transmitter coil, as described above. In FIG. 6, the wireless power transmitter coil is represented by inductance Ltx and resistance Qtx. Also depicted in FIG. 6 are parasitic inductances Lp/2 and resistance Rtxdc/2, associated for example with a cable coupling the wireless power transmitter coil to the inverter, e.g., in a wireless charger incorporating a connector/boot, cable, and puck arrangement. Finally, inverter 514 can be coupled to the wireless power transmitter coil by tuning capacitors Ctx.

Wireless power receiver 620 can include a receiver coil, represented by inductance Lrx and resistance Qrx. Additionally, the wireless power receiver model can include DC resistances Rrxdc/2 associated with the various wiring, connections, etc. The wireless power receiver may also include a shunt capacitance Cs coupling the AC lines from the receiver coil. The AC lines may also be coupled to the rectifier (not shown in FIG. 6). Also included in the circuit are tuning capacitors Crx1 and Crx2. Tuning capacitors Crx1 are always present in the circuit, while tuning capacitors Crx2 may be selectively connected in parallel with tuning capacitors Crx1 by actuation of switches M1/M2. These switches can be controlled by wireless power receiver control circuitry illustrated as PRx controller 526, which can drive the switches via “default high” gate drive terminals GH1 and GH2, as described in greater detail below. The AC lines from the wireless power receiver coil may also be coupled to the wireless power receiver control circuitry 526 via terminals AC1/AC2.

As described above, tuning capacitors Crx1 and Crx2 can be used to tune the wireless power receiver circuitry for operation at different frequencies. For lower operating frequencies, more capacitance in the coil tank circuitry may be required, and thus it would be desirable to close switches M1/M2 when operating at lower frequencies to appropriately tune the circuit. Conversely for higher operating frequencies, less capacitance may be required, and thus it would be disable to open switches M1/M2 when operating at higher frequencies to appropriately tune the circuit. As described above, the default/initial/startup mode is lower frequency power transfer. However, at initial startup from a zero power state, switches M1 and M2 are open, meaning the circuit is tuned for higher frequency operation. (The default state of switches M1/M2 is a function of device availability as a default on state would require depletion mode FETs, which may not be readily available with appropriate power handling characteristics, as well as the increased complexity of potentially having to generate negative drive voltages, etc.).

To address this issue, the PRx controller 526 can be designed with gate drive outputs that default to a high condition. Complementary gate drive outputs (not shown) can default to a low condition). At initial startup, most of the internal circuitry of PRx controller 526 can default to an off state until the power supply voltage, which can be supplied by the rectifier output voltage Vrect, reaches a certain level. This can reduce the current requirements of PRx controller 526. In this state, the default high gate drive terminals GH1/GH2 can be configured to track the power supply voltage provided to PRx controller 526. Thus, once the power supply voltage (i.e., Vrect) reaches the turn on threshold of switches M1/M2, these switches can close, retuning the circuit for lower frequency operation, increasing the rate at which power can be delivered to the PRx, and accelerating the startup process. Once the rectifier output voltage exceeds an undervoltage lockout threshold, firmware running on a processor of PRx controller 526 can begin executing and can control the gate drive terminals GH1/GH2 as required to tune the circuit appropriately.

FIG. 7 illustrates a flowchart 700 of a startup sequence for a PRx controller 526. After startup at block 771, in block 772, circuitry within PRx controller 526 can monitor the rectifier output voltage Vrect to determine whether it exceeds a low voltage start threshold Vlvstart. This may take on a variety of values as appropriate for the given implementation. In some embodiments the low voltage start threshold can be 1.5V, corresponding to a level at which PRx controller 526 can control the tuning switches and rectifier operating mode. If this threshold has not been met (block 773), the bulk of PRx controller 526 can remain off, and monitoring can continue (block 772). Once the threshold is exceeded, PRx controller, e.g., an operating subset of the control circuitry therein, can begin operating the rectifier in boost mode (block 774), for example by closing one low side switch of the rectifier, assuming the rectifier is constructed as an active full bridge rectifier. Additionally, at this point, the default high gate drive terminals GH1/GH2 can have sufficient voltage to re-tune the wireless power receiver circuit for lower voltage operation (block 775), improving the power transfer level with a PTx that defaults to a low(er) frequency initial wireless power transfer state.

In block 776, control circuitry within PRx controller 526 can continue monitoring the rectifier output voltage (which is also the power supply to PRx controller 526) to determine whether it has exceeded an undervoltage lockout threshold Vuvlo. If so, then the controller firmware can startup (block 777), otherwise, the control circuitry can continue monitoring the rectifier output voltage until this threshold is met. Once the controller firmware starts, “normal” PRx controller operation can resume, with the full programmable functionality of PRx controller 526 being provided.

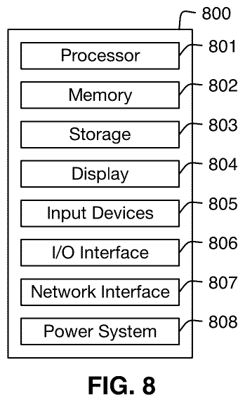

FIG. 8 is a block diagram of an electronic device 800 that can be the wireless power receiver, according to embodiments of the present disclosure. The electronic device 800 may include, among other things, one or more processors 801 (collectively referred to herein as a “processor” for convenience, which may be implemented in any suitable form of processing circuitry including homogenous multiprocessors, heterogenous multiprocessors, etc.), memory 802, nonvolatile storage 803, a display 804, input devices 805, an input/output (I/O) interface 806, a network interface 807, and a power system 808. The various functional blocks shown in FIG. 8 may include hardware elements (including circuitry), software elements (including machine- executable instructions), or a combination of both hardware and software elements (which may be referred to as logic). The processor 801, memory 802, the nonvolatile storage 803, the display 804, the input devices 805, the input/output (I/O) interface 806, the network interface 807, and/or the power system 808 may each be communicatively coupled directly or indirectly (e.g., through or via another component, a communication bus, a network, etc.) to one another to transmit and/or receive data amongst one another. It should be noted that FIG. 8 is merely one example of a particular implementation and is intended to illustrate the types of components that may be present in the electronic device 800.

By way of example, the electronic device 800 may include any suitable computing device, including a desktop or laptop/notebook, a portable electronic or handheld electronic device such as a wireless electronic device or smartphone, a tablet computer, a wearable electronic device such as a smart watch or head mounted display, and other similar devices and their accessories.

Processor 801 and other related items in FIG. 8 may be embodied wholly hardware or by hardware programmed to execute suitable software instructions. Furthermore, the processor 801 and other related items in FIG. 8 may be a single contained processing module or may be incorporated wholly or partially within any of the other elements within the electronic device 800. Processor 801 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. Processor 801 may include one or more application processors, one or more baseband processors, or both, and perform the various functions described herein.

In the electronic device 800 of FIG. 8, processor 801 may be operably coupled with a memory 802 and a nonvolatile storage 803 to perform various algorithms. Such programs or instructions executed by processor 801 may be stored in any suitable article of manufacture that includes one or more tangible, computer-readable media. The tangible, computer-readable media may include the memory 802 and/or the nonvolatile storage 803, individually or collectively, to store the instructions or routines. The memory 802 and the nonvolatile storage 803 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by processor 801 to enable the electronic device 800 to provide various functionalities.

In certain embodiments, the display 804 may facilitate users to view images generated on the electronic device 800. In some embodiments, the display 804 may include a touch screen, which may facilitate user interaction with a user interface of the electronic device 800. Furthermore, it should be appreciated that, in some embodiments, the display 804 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input devices 805 of the electronic device 800 may enable a user to interact with the electronic device 800 (e.g., pressing a button to increase or decrease a volume level). The I/O interface 806 may enable the electronic device 800 to interface with various other electronic devices, as may the network interface 807. In some embodiments, the I/O interface 806 may include an I/O port for a hardwired connection for charging and/or content manipulation using a standard connector and protocol, such as a universal serial bus (USB), or other similar connector and protocol. The network interface 807 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 807 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 807 of the electronic device 800 may allow communication over the aforementioned networks (e.g., 5G, Wi-Fi, LTE-LAA, and so forth).

The network interface 807 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

The power system 808 of the electronic device 800 may include any suitable source of power, such as a rechargeable battery (e.g., a lithium ion or lithium polymer (Li-poly) battery) and/or a power converter, including a DC/DC power converter, an AC/DC power converter, a power adapter (which may be external), a wireless power transfer system, etc.

The foregoing describes exemplary embodiments of wireless power transfer systems that may be able to communicate certain information between the PTx and PRx in the system. Entities implementing such technology should take care to ensure that, to the extent any sensitive information is used in particular implementations, that well-established privacy policies and/or privacy practices are complied with. In particular, such entities would be expected to implement and consistently apply privacy practices that are generally recognized as meeting or exceeding industry or governmental requirements for maintaining the privacy of users. Implementers should inform users where personally identifiable information is expected to be transmitted in a wireless power transfer system and allow users to “opt in” or “opt out” of participation. For instance, such information may be presented to the user when they place a device onto a power transmitter, if the power transmitter is configured to poll for sensitive information from the power receiver.

Described above are various features and embodiments relating to improvements in wireless power transfer systems. Such arrangements may be used in a variety of applications but may be particularly advantageous when used in conjunction with electronic devices such as mobile phones, tablet computers, laptop or notebook computers, and accessories, such as wireless headphones, styluses, etc. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A wireless power receiver comprising:
a wireless power receiving coil configured to have a current induced therein by a wireless power transmitter;
a rectifier that receives the current from the wireless power receiving coil and produces a rectifier output voltage therefrom; and
control circuitry coupled to the wireless power receiving coil and the rectifier that:
initiates wireless power transfer at a first frequency responsive to the wireless power receiver being coupled to the wireless power transmitter;
samples the rectifier output voltage in a stable region following an initial ramp up of the rectifier output voltage;
compares the sampled rectifier voltage to a threshold; and
if the sampled rectifier output voltage is greater than the threshold, initiates wireless power transfer at a second frequency that is higher than the first frequency; or
if the sampled rectifier output voltage is not greater than the threshold, continues wireless power transfer at the first frequency.

2. The wireless power receiver of claim 1 wherein if the sampled rectifier output voltage is greater than the threshold, the control circuitry further provides a notification indicating the transition to wireless power transfer at the second frequency.

3. The wireless power receiver of claim 2 wherein the notification includes at least one of an audible notification or a visual notification.

4. The wireless power receiver of claim 3 wherein the visual notification includes a notification on a display of the wireless power receiver.

5. The wireless power receiver of claim 1 wherein if the sampled rectifier output voltage is not greater than the threshold, the control circuitry further provides a notification indicating the continued wireless power transfer at a lower operating parameter.

6. The wireless power receiver of claim 5 wherein the notification includes at least one of an audible notification or a visual notification.

7. The wireless power receiver of claim 6 wherein the visual notification includes a notification on a display of the wireless power receiver.

8. The wireless power receiver of claim 1 wherein wireless power transfer at the second frequency transfers power at a greater rate than wireless power transfer at the first frequency.

9. A wireless power receiver comprising:
a battery;
a wireless power receiving coil configured to have a current induced therein by a wireless power transmitter;
a rectifier that receives the current from the wireless power receiving coil and produces a rectifier output voltage therefrom, wherein the rectifier output voltage is supplied to charge the battery; and
control circuitry coupled to the wireless power receiving coil and the rectifier that:
initiates wireless power transfer at a first frequency responsive to the wireless power receiver being mated to the wireless power transmitter in a low battery condition;
checks battery status to determine if battery condition can accommodate a transition to wireless power transfer at a second frequency higher than the first frequency;
checks wireless power transfer link efficiency to determine if a wireless power transfer link with the wireless power transmitter can accommodate wireless power transfer at the second frequency; and
if the battery status can accommodate the transition to wireless power transfer at the second frequency and the wireless power transfer link can accommodate wireless power transfer at the second frequency, initiates wireless power transfer at the second frequency; or
if either the battery status cannot accommodate the transition to wireless power transfer at the second frequency or the wireless power transfer link cannot accommodate wireless power transfer at the second frequency, continues wireless power transfer at the first frequency.

10. The wireless power receiver of claim 9 wherein the control circuitry checks battery status to determine if battery condition can accommodate a transition to wireless power transfer at a second frequency higher than the first frequency by receiving a signal indicating battery condition from a battery management system of the wireless power receiver.

11. The wireless power receiver of claim 10 wherein the signal indicating battery condition is based at least in part on temperature.

12. The wireless power receiver of claim 10 wherein the signal indicating battery condition is based at least in part on battery aging.

13. The wireless power receiver of claim 10 wherein the signal indicating battery condition is based at least in part on battery state of charge.

14. The wireless power receiver of claim 9 wherein the control circuitry checks wireless power transfer link efficiency to determine if a wireless power transfer link with the wireless power transmitter can accommodate wireless power transfer at the second frequency by:
determining whether the rectifier output voltage and a rectifier output current reach respective target values within a time limit;
if the rectifier output voltage and the rectifier output current do not reach respective target values within the time limit, inferring the presence of a foreign object and continuing wireless power transfer at the first frequency;
if the rectifier output voltage and the rectifier output current do reach respective target values within the time limit, calculating efficiency of the wireless power transfer link;
if the calculated efficiency does not exceed a first threshold, inferring the presence of a foreign object and continuing wireless power transfer at the first frequency;
if the calculated efficiency exceeds the first threshold, but does not exceed a second threshold, continuing wireless power transfer at the first frequency; and
if the calculated efficiency exceeds both the first and second thresholds, initiating wireless power transfer at the second frequency.

15. The wireless power receiver of claim 9 wherein wireless power transfer at the second frequency transfers power at a greater rate than wireless power transfer at the first frequency.

16. The wireless power receiver of claim 9 wherein continuing wireless power transfer at the first frequency and initiating wireless power transfer at the second frequency each comprise providing respective notifications, wherein the respective notifications include at least one of an audible or visual notification.

17. A wireless power receiver comprising:
a wireless power receiving coil configured to have a current induced therein by a wireless power transmitter;
a rectifier that receives the current from the wireless power receiving coil and produces a rectifier output voltage therefrom, wherein the rectifier output voltage is supplied to charge a battery;
a plurality of tuning capacitors coupling the wireless power receiving coil and the rectifier, the plurality of tuning capacitors including one or more switched capacitors selectively couplable to or de-couplable from the wireless power receiving coil by respective switching devices; and
control circuitry coupled to the wireless power receiving coil and the rectifier that:
initially disables one or more components of the control circuitry until a rectifier output voltage exceeds a low voltage start threshold;
upon the rectifier output voltage exceeding the low voltage start threshold, operates the rectifier in a boost mode to increase the rectifier output voltage, wherein the control circuitry further includes one or more default high control outputs coupled to the switching devices that cause the one or more switched capacitors to be coupled to the wireless power receiving coil upon the rectifier output voltage reaching the low voltage start threshold; and
upon the rectifier reaching an undervoltage lockout threshold, enables the one or more initially disabled components of the control circuitry, wherein the one or more initially disabled components of the control circuitry can assume control of the rectifier and switching devices.

18. The wireless power receiver of claim 17 wherein the one or more switched capacitors selectively couplable to or de-couplable from the wireless power receiving coil by respective switching devices tune the wireless power receiver for operating at a first wireless power transfer frequency when the one or more switched capacitors are coupled to the wireless power receiving coil and tune the wireless power receiver for operating at a second wireless power transfer frequency when the one or more switched capacitors are de-coupled from the wireless power receiving coil.

19. The wireless power receiver of claim 18 wherein the second wireless power transfer frequency is higher than the first wireless power transfer frequency.

20. The wireless power receiver of claim 19 wherein wireless power transfer at the second wireless power transfer frequency transfers power at a greater rate than wireless power transfer at the first wireless power transfer frequency.
